(19) United States
(12) Patent Application Publication
(10) Pub. No.: US 2010/0044506 A1
(43) Pub. Date: Feb. 25, 2010

(54) AIRCRAFT

(76) Inventors: Alan John Smith, Victoria (AU); Grenfell Saxon Ruddock, South Australia (AU); Matthew Tetlow, South Australia (AU)

Correspondence Address: TRASKBRITT, P.C., P.O. BOX 2550, SALT LAKE CITY, UT, 84110, US

(21) Appl. No.: 12/449,015

(22) PCT Filed: Jan. 24, 2008
(86) PCT No.: PCT/AU2008/000076

§ 371 Date: Jul. 20, 2009

(30) Foreign Application Priority Data
Jan. 24, 2007 (AU) 2007900335

(51) Int. Cl. B64C 25/54; B64C 25/10; B64C 25/66; B64C 35/00; B64C 37/00

(52) U.S. Cl. 244/101; 244/105

(57) ABSTRACT

A method of retrofitting retractable floats to an aircraft such as a floatplane. The aircraft considered have existing landing gear such as wheeled landing gear to equip said aircraft to optionally takeoff or land on a solid surface such as a beach or landing strip, the method including the steps of: a) mounting at least one float retraction arm to the aircraft; and b) attaching the floats to the float retraction arm. Each float includes an air travel position in which it is secured close to the float retraction arm mounting location and/or the fuselage, and a deployed position in which the float is lower than the existing landing gear. In following the float retraction paths of travel of the float retraction arm and the floats between the air travel and deployed positions, the floats do not interfere with the existing landing gear or its operation.

### FIELD OF INVENTION

This invention relates to improvements in aircraft. The invention in some of its many aspects represents improvements in, modifications of or additions to aircraft that can operate with fixed floats or with retracting floats.

### INCORPORATION OF SPECIFICATIONS BY REFERENCE

The entire contents of Australian patent application No. 2007900335 entitled “Improvements in aircraft” by the Applicant are incorporated herein by reference.

The invention in some of its many aspects represents improvements in, modifications of or additions to the “twin float aircraft” disclosed in U.S. Pat. No 6,866,224. The entire contents of U.S. Pat. No 6,866,244 (referred to below as “the US Specification”) are incorporated herein by reference.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

For convenience, the invention and the prior art will be generally discussed below in relation to floatplanes. However, it is to be understood that the invention is not limited to this application and includes other sea planes, such as flying boats.

Floatplanes provide an alternative to aircraft which require a runway for take off and landing, and allow people to access remote areas where a runway is not available.

Floats on floatplanes may be characterized by the “dead rise” angle of the bottom of the hull of the float. The “dead rise” angle is measured at the position when the hull planes prior to the take off between water level and a line joining main keel and external chine, and is related to the level of lift force generated.

Current design floats on floatplanes have relatively low “dead rise” angles up to a maximum of 31.5 degrees. These low “dead rise” angles may enable a shorter lake off distance, but can cause other significant problems, such as a rougher, jolting ride in choppy water, during take off, landing or taxiing.

There is therefore a need for an undercarriage structure that addresses the shock forces transmitted through the floatplane structure, improves the ride comfort or at least provides a useful alternative to current arrangements.

An object of the present invention is to ameliorate the aforementioned disadvantages of the prior art or to at least provide a useful alternative thereto.

### STATEMENT OF INVENTION

In one aspect of the invention, there is provided a method of retrofitting retractable float means to an aircraft having existing landing gear to equip the aircraft to optionally takeoff from or land on a solid surface, the method including, in no particular order, the steps of:

a) mounting at least one float retraction arm to the aircraft so that the operation of the existing landing gear is unhindered: and

b) attaching float means to the float retraction arm,

the float means including an air travel position, in which the float means is secured close to the mounting location of the float retraction arm and/or the fuselage of the aircraft, and a deployed position in which the float means is lower than the existing landing gear;

wherein, in following the float retraction paths of travel of the float retraction arm and the float means between the air travel and the deployed positions, the float means does not interfere with the existing landing gear or its operation in landing on or taking off from a solid surface.

The existing landing gear is preferably wheeled landing gear, but may include skis, belts or other locomotive means. The existing land gear may be retractable for air travel along a landing gear retraction path and at least one of the float retraction paths may intersect with the landing gear retraction path.

The float means may be located in the landing gear retraction path in the air travel position and the float retraction arm should be deployed to permit deployment of the existing landing gear.

The existing landing gear may be in the same fixed position for both for landing and air travel. The float retraction paths do not intersect with the fixed existing landing gear.

The float retraction arm may be capable of positioning the float means in a non-deployed extended position for landing on a solid surface. Accordingly, in the extended position, the float means may be higher than the lowermost point of the existing solid surface landing gear.

In another aspect, there is provided an aircraft having existing landing gear, the aircraft retrofitted with retractable float means to equip the aircraft to optionally takeoff from or land on a water surface, the aircraft including a float arrangement having:

a) at least one float retraction arm mounted to the aircraft so that the operation of the existing landing gear is unhindered;

b) float means attached to the retraction arm whereby the float means includes an air travel position in which the float means is secured close to the mounting location of the float retraction arm and a deployed position in which the float means is able to support the fuselage and wings of the aircraft above the water surface;

wherein the float retraction paths of travel of the float retraction arm and the float means between the air travel and the deployed positions do not interfere with the existing landing gear or its operation in landing on or taking off from a solid surface.

The float means may include a pair of floats. Each float may be positioned either side of a vertical longitudinal plane that bisects the fuselage. The float means may include a single float or a catamaran style float arrangement. The float means may include two or more float hulls in series. Preferably, the float means includes at least a pair of floats spaced to provide stability.

The aircraft may include an airfoil which can be deployed to increase lift during take off. The airfoil may be housed during air travel and non-use in a stub wing or another section associated with the fuselage.

The existing landing gear may be retractable. In some arrangements it may be desirable for the respective sweeps of the retraction paths of the float arrangement and the existing landing gear to intersect due to size and aerodynamic constraints, etc. In such arrangements, the float retraction arm and/or the float means may include a deflectable portion which, when in the air travel position, would interfere with the path of travel of the landing gear during extension or retraction. By deflecting the deflectable portion, such as hinged panel, a clear path is made for the existing land gear.

The attachment of the float means to the aircraft may involve a wide range of arrangements. The retraction means may include linear rams to displace the float means to the air travel position. Preferably the float means are rotated about one or more axes to achieve displacement through the float retraction paths. The hinge arrangement is preferably profiled to reduce drag. The attachment of the float retraction arm to the aircraft at the mounting location may include a butt hinge to reduce drag during take off and flight.

The float means may include an articulated section pivotable relative to the float body. This may assist in improving the hydrodynamics properties of the float means. The articulated section may be a nose and/or a tail section of the float means that is deployable to provide improved buoyancy and/or is retractable to reduce drag. The articulated section may be a tail section movable to provide loading or unloading access to a tailgate of the aircraft, such as Boeing C17 aircraft.

The float means may include expansion means to increase the buoyancy and/or the surface area of the float means. The expansion means may be in the form of an inflatable bladder, e.g., fed by compressed air such as from a canister, air lank or air compressor.

The float means may be operable to tilt the nose of the float means downward to achieve a different nose down angle. This may assist in effecting a safer or more comfortable landing. It may also be appropriate where a single propeller arrangement precludes the float means being positioned permanently more forward on the aircraft.

The float means may include ducts to increase planing during take off. The ducts may comprise linear or curved conduits through the body of the float means. The duct inlets may be covered during flight by retracting the float means into a position where the duct inlets are covered. For example, this may be achieved by a wing, fuselage feature or panier panel.

In another aspect, it has been found that the shock loads transmitted to a floatplane can be reduced significantly by providing a suspension system between the floats and the aircraft that allows relative movement between the floats and the aircraft with a calculated resistance to this movement that absorbs a lot of the shock loads. The float arrangement may therefore include suspension means to at least partially absorb shock loads transmitted from the float means to the fuselage during landing or take off.

The invention may therefore involve a suspension system for use in a floatplane having a float, the system including means connecting the float to the floatplane and suspension means placed between the float and the connecting means.

The floatplane preferably has two floats, but may have any number of floats.

The connecting means may take the form of a tower, a frame, a bar, or any construction that is sufficiently strong enough to securely connect the float to the floatplane or the fuselage or body thereof.

The suspension system may incorporate a spring means and may require a dampening means. The spring means may operate by bending, torsion, compressing, stretching etc. The dampening means may operate by friction, resistance to flow of a fluid, gas or magnetic force etc. The spring means and the dampening means may be combined, for example, in a rubber block. The suspension system may be incorporated in the design of the float itself by controlled deflection of the float structure.

Preferably, the suspension means is chosen from the group: one or more leaf springs, torsion links and/or hydraulic dampeners.

Optionally, the suspension means may include at least one of pivotal arms, springs and/or rubber parts.

The aggregation of ice on non-retractable floats of floatplanes has caused problems with the significant weight burden that may be added during flight. In the invention, the retraction of the float means to a position close to the fuselage reduces the exposed surface area of the float means to the air stream and thereby reduces the amount of ice accumulated thereon. Moreover, the compact shape of the floats according to an aspect of the invention provides a more streamlined float body, thereby increasing airflow past the float body and hindering the formation of ice thereon.

It has also been found that ice formed on the front of the floats can be reduced and/or eliminated by the propeller of the floatplane if the floats are placed immediately behind or near the propeller. This has the effect of slinging ice away from the fuselage and also exposes the surfaces of the retracted float means to a faster air stream than the normal slipstream. The float means in the air travel position may be positioned behind the air wake of a propeller to minimise ice aggregation on the float means. The air flow created by the propeller helps prevent ice from forming on the front of the floats. For floatplanes with retracted floats, the movement of the float in relation to the aircraft can help crack ice build-up on the float during flight.

According to another aspect of the present invention, there is provided a method for de-icing a float of a floatplane, the method including the step of locating the float behind a propeller of the floatplane, so that air moved by the propeller impinges on at least part of the float susceptible to ice build-up.

In another aspect, the invention provides a method of de-icing a retracted float of a floatplane, the method including the step of causing the float to at least partially move away from the floatplane during flight.

To achieve a softer ride in choppy water, the bottom of float incorporates greater “dead rise” angle. It is found that the “dead rise” angle of greater than 31.5 degrees gives a “Deep V” look to float and results in a softer plane ride in choppy water than in the case of conventional floats. The float means may include a float body having a hull with a dead rise angle of greater than 31.5°.

Unlike the conventional floats which limit the weather/sea conditions under which floatplanes can operate, and result in more frequent aircraft maintenance due to damage caused by vibration of sea waves and the shock forces transmitting through the floatplane structure, the “Deep V” floats can increase operational availability and reduce maintenance costs. Because of the improved tolerance of floatplanes made according to the invention to rough water, floatplanes with “Deep V” floats permit a longer take off distance, resulting in wider range of aircraft available to be used as floatplanes, rather than the typical “Short Take Off and Landing” (STOL) planes commonly used as floatplanes today. The longer take off is possible because there is a reduced need to get off the water quickly to escape the damaging shockloads suffered by traditional floatplanes with shallow V floats.

Such an arrangement can be particularly advantageous where “deep V” floats are employed to reduce shock loads on an aircraft and to increase human comfort, as well as reducing structural fatigue of aircraft components. However, the deep V configuration may lead to a longer take off run due to the reduced hydrodynamic lift and therefore has its disadvantages. To ameliorate this aspect, a float of the invention may include the addition of a strake to the hull of the float. The strake is preferably retractable. The float means may therefore include a retractable strake that is deployable during takeoff to increase the water engaging surface area of the float means, but is retractable to provide acceptable aerodynamic properties during air travel.

The floats means according to the present invention when assessed from an end view may generally present a much taller and narrower construction in which the height and width or the float through a transverse section of the float body are similar, compared to flatter, wider prior art floats, thereby providing a reduced surface area for ice accumulation. The float body may have an upper casing that, together with the hull, defines an internal float volume that may vary, depending on the level of buoyancy to be achieved by the float. The float body in transverse section may have a substantially similar height, taken from the main keel of the hull to the apex of the upper casing, and width, extending between the outermost chines of the hull. The height to width ratio is preferably within the range of 1.0:1.6 to 0.6:1.0, more preferably 0.7:1.0 to 1.0:1.0, and still more preferably 0.7:1.0 to 0.8:1.0.

According to another aspect of the present invention, there is provided a float for use in a floatplane, the float having a hull with a keel adapted to contact water, at least two chines substantially parallel to the keel, one each of the chines being located at an outer edge on opposing sides of the hull wherein an angle formed between the water level and a line from the keel to one of the outer edge chines is greater than 31.5 degrees.

Preferably, the float has four chines. It is preferred that there are longitudinal concave surfaces between the chines.

### BRIEF DESCRIPTION OF THE DRAWINGS

As will be apparent to a person skilled in the art, an aspect of this invention may be used in combination with one or more of the other aspects. The description in connection with the drawings is intended to be illustrative and not limiting on the scope of the various aspects of the invention. Preferred features of the present invention will now be described with particular reference to the accompanying drawings. In the drawings:

FIG. 1(a) is a perspective view of part of the undercarriage of a floatplane, showing conventional prior art floats.

FIG. 1(b) is a perspective view of a first embodiment of a suspension system for a floatplane having fixed floats according to the first aspect of the invention;

FIG. 1(c) is a front view in the direction A-A of FIG. 1(b) of the fixed floats and suspension system of the embodiment of FIG. 1(b);

FIG. 1(d) is a perspective view of a second embodiment of the suspension system for a floatplane having fixed floats according to the first aspect of the invention;

FIG. 1(e) is a front view in the direction of B-B of FIG. 1(b) of the fixed floats and suspension system of the embodiment of FIG. 1(d);

FIG. 1(f) is a perspective view of a third embodiment of the suspension system for a floatplane having fixed floats according to the first aspect of the invention;

FIG. 2(a) is a front view of a fourth embodiment of the suspension system for a floatplane having retracting floats according to the first aspect or the invention;

FIG. 2(b) is a front view of a fifth embodiment of the suspension system for a floatplane having retracting floats according to the first aspect of the invention;

FIG. 2(c) is a front view of a sixth embodiment of the suspension system for a floatplane having retracting floats according to the first aspect of the invention;

FIG. 2(d) is a side view of a seventh embodiment of the suspension system for a floatplane having retracting floats according to the first aspect of the invention;

FIG. 2(e) is a front view of a eighth embodiment of a suspension system for a floatplane having retracting floats according to the first aspect of the invention;

FIG. 3(a) is a perspective view of fixed floats for a floatplane, showing areas especially vulnerably to ice build-up;

FIG. 3(b) is a perspective view of a retracted float for a floatplane according to the third aspect of the invention;

FIG. 3(c) is a perspective view of a floatplane having retracted floats according to the second aspect of the invention;

FIG. 4 is a front view of a preferred embodiment of a float according to the fourth aspect of the invention;

FIGS. 5a-5c are underside perspective views of different types of aircraft comprising retractable floats according various embodiments of the invention;

FIG. 5d is a perspective view from above an aircraft in accordance with another embodiment of the invention incorporating canard stub wings;

FIG. 6a is a perspective view from above an aircraft in accordance with another embodiment of the invention incorporating deployable extra lift wings;

FIG. 6b is a perspective view of the extra lift wing shown in FIG. 6a in greater detail;

FIGS. 7a-7c are perspective views of a butt hinge in retracted, extending and extended positions, respectively, according to another embodiment of the invention;

FIGS. 7d-7f are schematic side sectional views of the butt hinges respectively shown in FIGS. 7a-7c;

FIGS. 7g-7h are perspective views of a butt hinge in retracted and extended positions, respectively, according to another embodiment of the invention;

FIGS. 8a and 8b are sectional views on the keel line of a float according to one embodiment of the invention;

FIG. 9 is a perspective view from below of a large freight capacity aircraft showing a rear loading tailgate according to one aspect of the invention;

FIG. 10 is an end view of the aircraft shown in FIG. 9;

FIG. 11a is a perspective view from below a twin float aircraft according to one embodiment;

FIG. 11b is a sectional view taken along the line A-A in FIG. 11a;

FIGS. 11c and 11d are sectional view similar to that of FIG. 11b showing a float in different positions;

FIG. 11e is a schematic side view of the aircraft shown in FIG. 11a and demonstrating deflection of the float;

FIG. 12a is a side view of a prior art float;

FIGS. 12b and 12c are respective sectional views of the float shown in FIG. 12a at lines B-B and C-C, respectively;

FIG. 12d is a side view of a float according to one embodiment of the invention;

FIGS. 12e and 12f are section views of the float shown in FIG. 12d along lines D-D and E-E, respectively;

FIG. 13a shows a sectional view of part of a fuselage of an aircraft according to one embodiment;

FIG. 13b shows a section view of the fuselage shown in FIG. 13a with the float in an extended position;

FIGS. 14a and 14b show sectional views of a twin float aircraft according to one embodiment of the invention;

FIG. 14c is a sectional view of the aircraft shown in FIG. 14b along lines H-H;

FIGS. 15a-15d show perspective views of blister variable volume floats according to two different embodiments of the invention;

FIGS. 16a and 16b are sectional views of an aircraft demonstrating wheels within floats according to one embodiment of the invention;

FIGS. 17a and 17b are side sectional views of an articulated float according to another embodiment;

FIG. 18 is a partial perspective view of an aircraft showing a storage capacity in a stub wing;

FIG. 19 is a perspective view looking down from the port side of the space between a pair of floats according to another embodiment;

FIG. 20a is a partial end and sectional view of an aircraft having a retractable float and a fixed wheel;

FIG. 20b is a partial underside plan view of the aircraft shown in FIG. 20a with floats shown in solid lines in a retracted position;

FIG. 20c is a front elevation of the aircraft shown in FIG. 20a;

FIG. 20d is a side elevation of the aircraft shown in FIG. 20a with floats shown in broken lines in a retracted position;

FIG. 20c is a side elevation of the aircraft shown in FIG. 20a;

FIGS. 21a and 21b are side sectional views of an aircraft having a forward moveable float;

FIG. 22 is a perspective view of an aircraft having a pannier with its own wheels according to another embodiment;

FIG. 23a is a side elevation of an embodiment of an aircraft having a retractable and pivotable float;

FIG. 23b is a schematic representation of the pivot range of the float shown in FIG. 23a;

FIG. 24a is a schematic front elevation of an aircraft according to another embodiment of the invention;

FIG. 24b is a plan view of the aircraft shown in FIG. 24a;

FIG. 24c is a side view of the aircraft shown in FIG. 24a;

FIG. 25a is a side elevation of a flying boat according to an embodiment of the invention;

FIG. 25b is a plan view from below of the flying boat shown in FIG. 25a;

FIGS. 26a-26d are end sectional views of a Pilatus PC12 aircraft showing configurations for air, water, land and beach respectively with a retractable float shown in various positions;

FIGS. 27a-27c are partial end sectional views of a Bombardier Dash 8 tah aircraft in three different positions, air, water, land and beach, respectively of a retractable float;

FIGS. 28-28C are partial and section views of a C17 aircraft showing three different positions, air, water, land and beach, respectively of a retractable float;

FIG. 29a is a side view of a float according to one embodiment having an articulated tail;

FIG. 29b is a sectional view taken through line A-A of FIG. 29a; and

FIG. 29c is a sectional view of the float shown in FIG. 29b taken along line B-B.

### DETAILED DESCRIPTION OF THE DRAWINGS

The twin float aircraft disclosed in the US Specification has a pair of floats which are retractable during flight. The retracted floats may nestle against the aircraft fuselage if retrofitted or may be retracted into the aircraft body if incorporated in the aircraft during manufacture.

In some aspects, this invention is concerned with sea planes which can operate without twin floats.

As will be apparent to a person skilled in the art, an aspect of this invention may be used in combination with one or more of the other aspects. Further, some or more of these may be combined with the inventions disclosed in the US Specification. For convenience, the various aspects in this current specification will be discussed in conjunction with relevant accompanying sketches. The description in connection with the drawings is intended to be illustrative and not limiting on the scope of the various aspects of the invention.

It will be appreciated that in the US Specification the inventions were illustrated in relation to a twin float aircraft which took the form of a sea plane. As will be readily appreciated by one skilled in the art, the inventions in the US Specification can be applicable to other types of aircraft.

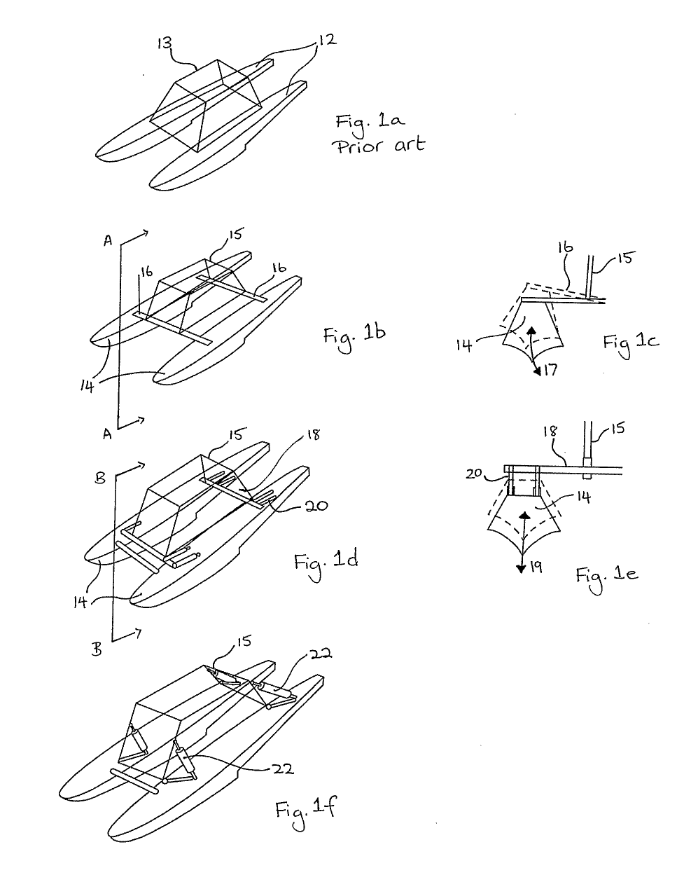

Referring to FIG. 1(a), there is presented a prior art version of a pair of conventional fixed floats 12 connected via tower 13 to a floatplane (not shown). The fixed floats 12 are attached to the floatplane by directly bolting them to tower 13, which takes the form of a truncated pyramidal tower structure, directly bolted to the aircraft. This type of structure allows shock loads generated by fixed floats 12 hitting the water and waves on the water to be transmitted directly to the aircraft, thus contributing to damage to the aircraft structure, causing discomfort to passengers and adding to pilot fatigue.

Embodiments of the invention shown in FIGS. 1(b) to (f) are demonstrated on aircraft with fixed floats.

FIGS. 1(b) and (c) show an embodiment of the suspension system using leaf springs. In FIGS. 1(b) and (c), fixed floats 14 are attached to bars 16. Bars 16 connect floats 14 to the aircraft (not shown) through lower 15. As can be seen in FIG. 1(b), tower 15 has a narrower base than tower 13 in FIG. 1(a). Bars 16 include leaf springs which can bend up and down (sec arrows 17 from the position of float 14 shown in solid outline) acting as a suspension system to absorb shock loads generated by floats 14 striking the water during landing.

Arrow 17 in FIG. 1(c) shows how floats 14 can move between the position shown in dashed outline to that in solid outline, and in doing so to absorb shock.

Now turning to FIGS. 1(d) and (e), a second embodiment of the suspension system is shown using torsion bars 18 connected to tower 15. Fixed floats 14 are attached to torsion bars 18 by links 20, allowing fixed floats 14 to travel up and down (see arrows 19 from the position of float 14 shown in solid outline) to absorb shock loads when floats 14 hit the water.

Yet a third embodiment of the suspension system incorporating coiled spring hydraulic dampeners 22 (similar to those used in motor bikes), is shown in FIG. 1(f).

It will be appreciated that the suspension system may be positioned in any desirable manner and may take any desirable form other than the ones described above.

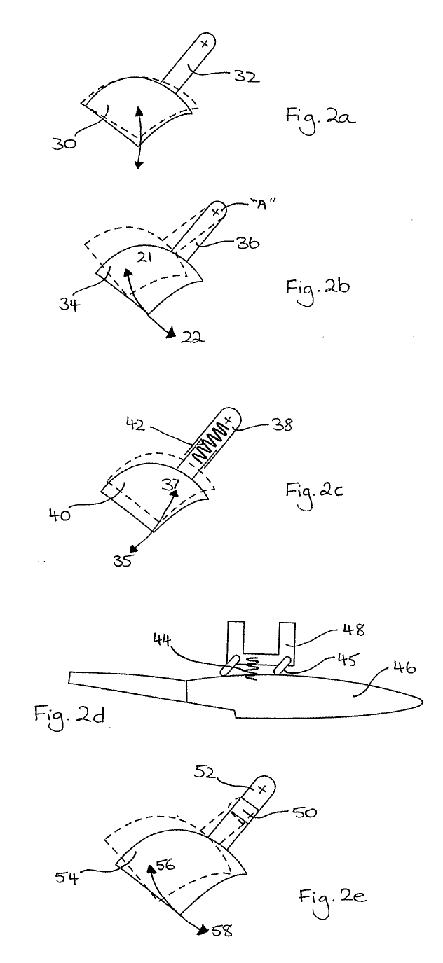

Embodiments of the suspension system invention shown in FIGS. 2(a) to (e) are demonstrated on aircraft with retracting floats.

FIGS. 2(a), (b) and (c) show the suspension system in different forms. A pair of floats and connecting arms is required, but only one of them is shown in the Figures. FIG. 2(a) shows retracting float 30 attached to arm 32 at one end of arm 32, while the other end of arm 32 is connected to the aircraft (not shown). Retracting float 30 is made of deformable material which allows retracting float 30 to deform, to some extent, to absorb the shock loads generated by retracting float 30 striking the water. Arm 32 is adapted to pivot, to retract float 30 close to or held within the body of the aircraft.

FIG. 2(b) shows a further embodiment of the suspension system, having float 34 attached to arm 36. Arm 36 can pivot at point “A” so that float 34 can be lowered for landing of the aircraft, or retracted for flight. Arm 36 is attached to the aircraft (not shown) using spring means, which is chosen from a core spring, a rubber block, a torsional spring and a spring included in an actuator dampener. The dashed outline shows the extent of travel (see arrows 21 and 23 from the position of float 34 shown in solid outline) to create a dampening effect overall for shock absorbing.

A similar effect can be achieved by using a different approach. For example, a further embodiment is shown in FIG. 2(c). A telescopic type of arm 38 has spring 42 within, allowing float 40 to travel forwards and away from arm 38 when float 40 hits the water, reducing shock. The dashed outline shows the extent of travel (see arrows 35 and 37) from the position of float 40 shown in solid outline to reduce shock.

It will be appreciated that the spring means may be positioned in any desirable manner and may take any desirable form other than the one described above. FIG. 2(d) shows a spring 44 placed externally between float 46 and frame 48. Float 46 is connected to frame 48 via pivotal arms 45. When float 46 strikes the water during landing, for example, spring 44 is adapted to be compressed so that shock loads can be reduced.

Another embodiment of suspension system that incorporates both spring means and dampening medium is shown in FIG. 2(e). Arm 52 has centre part 50 made of rubber, which is a good material to absorb shock loads. The flexibility of rubber part 50 allows float 54 to travel as shown by arrows 56 and 58 to reduce the shock loads, when float 54 hits the water.

It is common for aircraft to encounter atmospheric conditions that cause ice to accumulate on the aircraft. In particular, floatplanes with floats are more likely to encounter ice forming on the floats due to the large surface area of the floats. Ice is mostly formed on the front of the floats, in joints and on supporting structures.

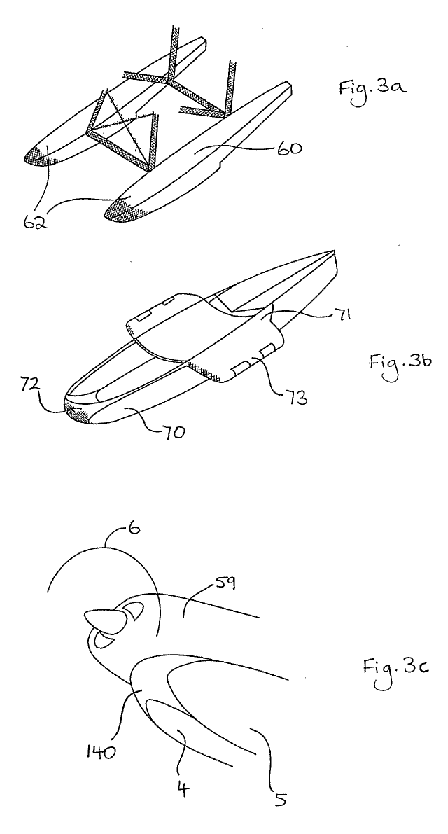

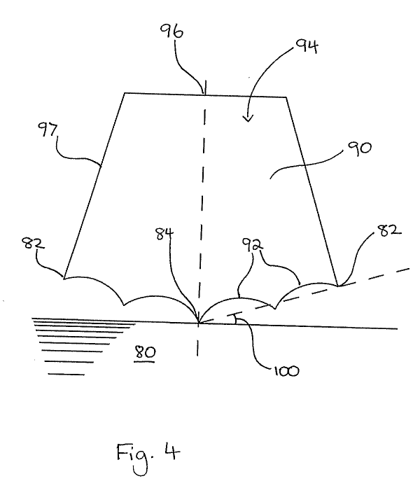

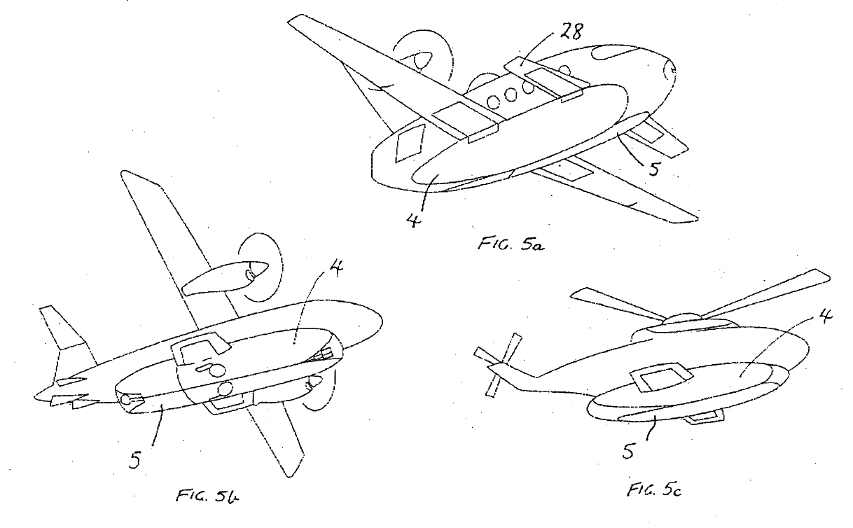

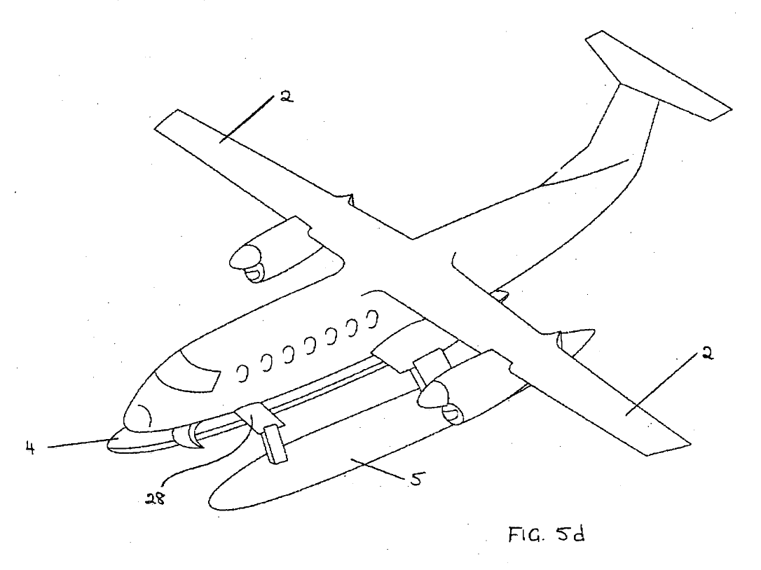

FIG. 3(a) shows ice forming on the front 62 of fixed float 60, while FIG. 3(b) shows ice forming on the front 72 of retracting float 70, on stub wings 73, and in joints 71.

In FIG. 3(c), there is shown a floatplane 59 having retracted floats 4, 5 in a retracted position, placed behind propeller, 6, resulting in reduction and/or elimination of ice build-up on the front of floats 4,5. Furthermore, a small degree of lowering of retracted floats 4, 5 from floatplane 59 during flight helps crack ice build-up formed on the floats 4, 5 near the joints (not shown) between floats 4, 5 and floatplane 59 during flight.

It is shown in FIG. 4 that float 90 of a floatplane has a “dead rise” angle 100 at the bottom of the hull of the float 90. The “dead rise” angle 100 is measured at the position when the hull planes prior to the lake off, between water level 80 and a line joining main keel 84 and external chine 82, and is related to the level of lift force generated.

In FIG. 4, the bottom of float 90 is shown having concave shaped portions 92. A “dead rise” angle is formed between water level 80 and the line joining main keel 84 and external chine 82. The “dead rise” angle 100 is greater than 31.5 degrees, giving a “Deep V” look to float 90 and resulting in a softer plane ride in choppy water than in the case of conventional floats.

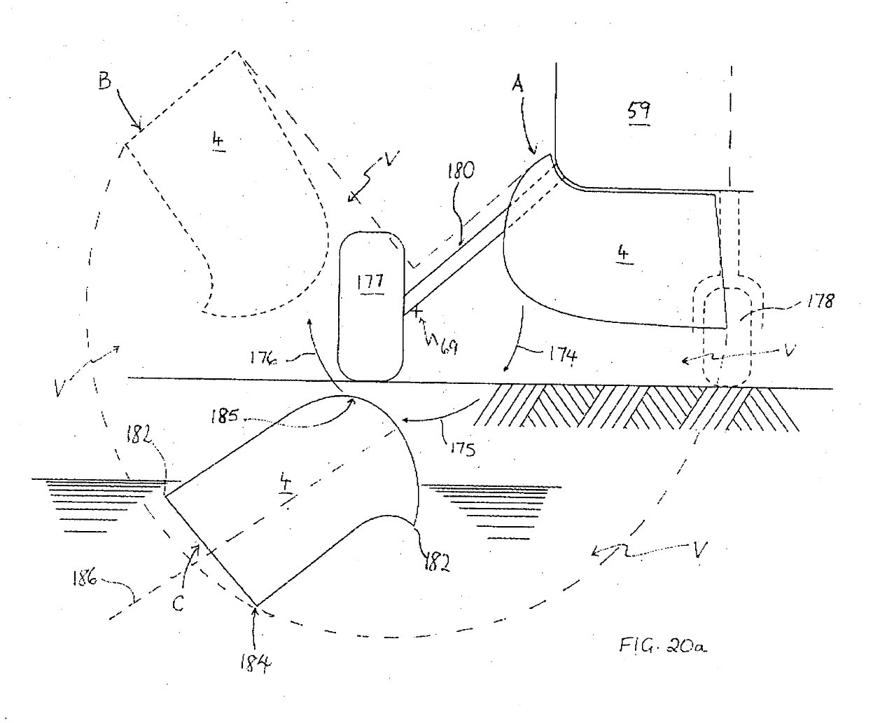

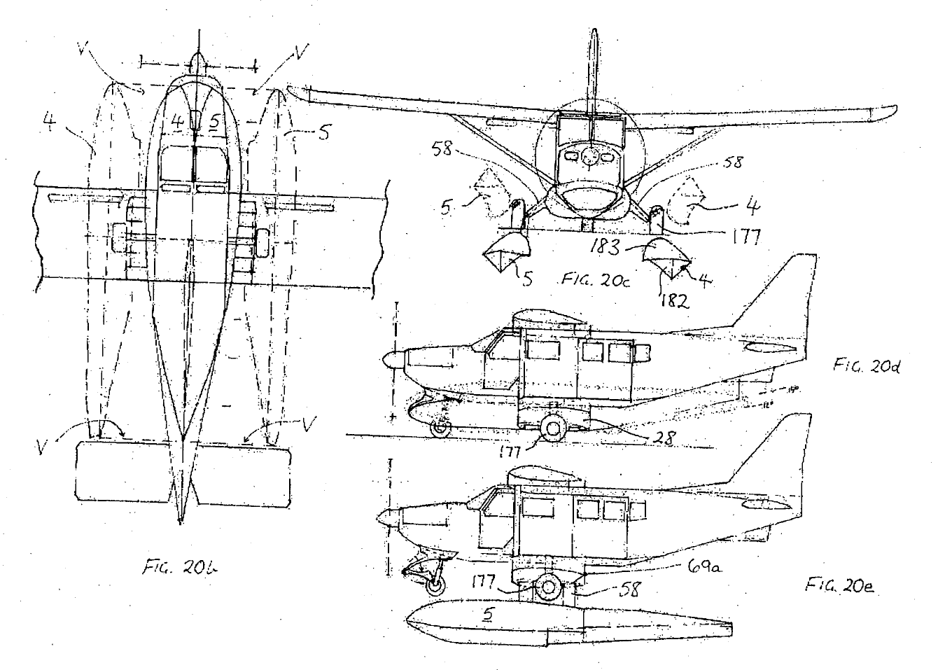

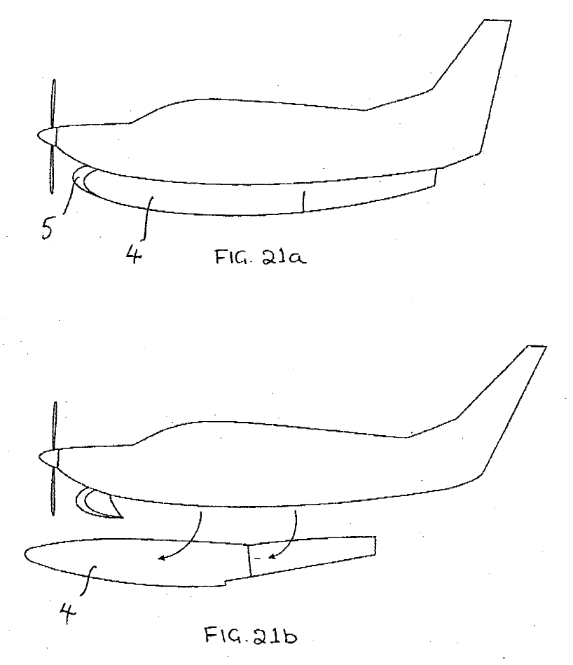

The floats 4,5 according to the present invention when assessed from an end view generally present a much taller and narrower construction in which the height and width of the float through a transverse section of the float body are similar, compared to flatter, wider prior art floats, thereby providing a reduced surface area for ice accumulation. The float body 94 has an upper casing 95 that, together with the hull 97, defines an internal float volume that may vary, depending on the level of buoyancy to be achieved by the float. For example, a small float 4 such as that shown on FIGS. 20a-c (see below) may have a float volume of about 1.6-1.7 m³. The float body 94 in transverse section as shown in FIGS. 4 and 20a may have a substantially similar height, taken from the main keel 84,184 of the hull 97 to the apex 96,185 of the upper casing 95, and width, taken from the outermost chines 82,182 of the hull 97. The height to width ratio is preferably within the range of 1.0:1.6 to 0.6:1.0, more preferably 0.7:1.0 to 1,0:1.0, and still more preferably 0.7:1.0 to 0.8:1.0.

FIGS. 5a-5c are underside perspective views of different types of aircraft comprising retractable floats according various embodiments of the invention. FIG. 5a shows an aircraft with canard stub wings 28 to which a forward section of of each of floats 4,5. FIG. 5b shows a conventional twin-engine aircraft in air travel or flight position with floats 4,5 retracted over existing landing gear (obscured). FIG. 5c retractable floats 4,5 are shown retrofitted to a helicopter.

FIG. 5d is a perspective view from above of an embodiment of an aircraft having canard stub wings. In FIG. 5d, only stub wing 28 can be seen. Float 5 is connected to the body of the aircraft at each of stub wing 28 and main wing 2. Float 4 is joined to stub wing 27 (not visible) and main wing 2 in a corresponding manner. Stub wings 27 and 28 are mounted forward of main wings 2 and provide additional support for the front end of floats 4 and 5, especially when these are long as shown in FIG. 2.

Stub wings 27 and 28 may be positioned in any desirable manner and may take any desirable form. They can have other functions apart from helping to stabilise floats 4 and 5, particularly when these are long. For example, stub wings 27 and 28 may form part of an integrated system where stub wings 27 and 28 are in wider chord form, linked by a saddle, to provide a four wheel “buggy” undercarriage system. An example of this is shown in FIG. 3 in the Australian specification.

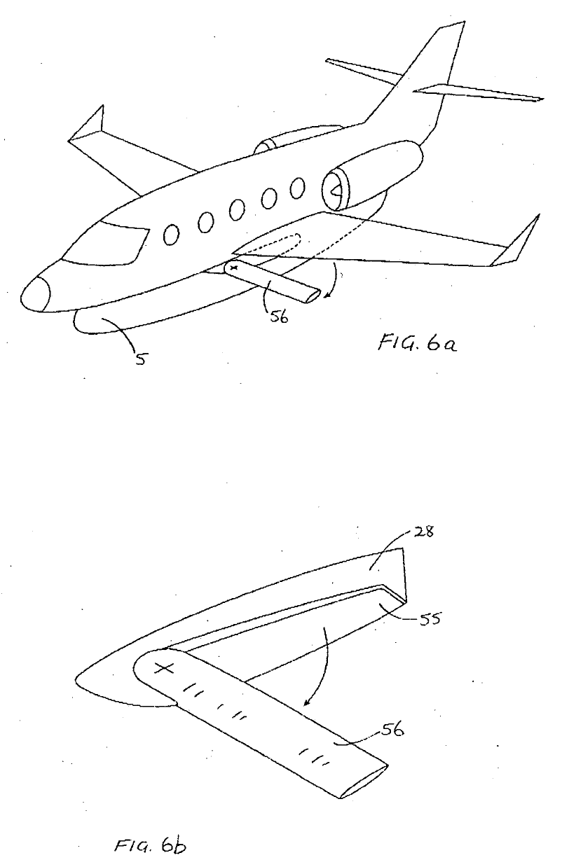

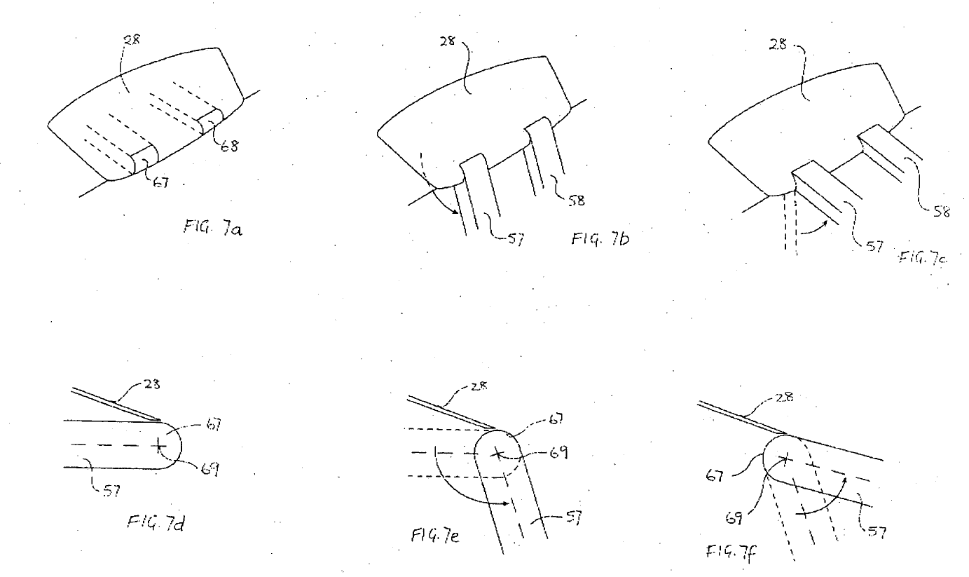

Stub wings, whether used for float connection or not, can have various other uses and benefits. For example, a stub wing may be used to fully or partially house an airfoil which can be deployed to increase lift during take off. An example is shown in perspective view in FIG. 6a, with more detail shown in FIG. 6b. Stub wing 28 in this embodiment (see FIG. 6b) includes recess 55 to accommodate airfoil 56. In both FIGS. 6a and 6b, airfoil 56 is shown in the deployed position to increase lift and hence lower landing speed, as well as to increase lift during lake off. This can be particularly useful for high speed aircraft, such as jets. In flight, airfoil 56 is retracted to nestle in recess 55, in order to reduce drag.

Stub wings can provide the sole point of attachment for the floats. Many of the illustrations referred to below can relate to support of a float by means of a stub wing alone, as well as in conjunction with a second support, such as from the main wing.

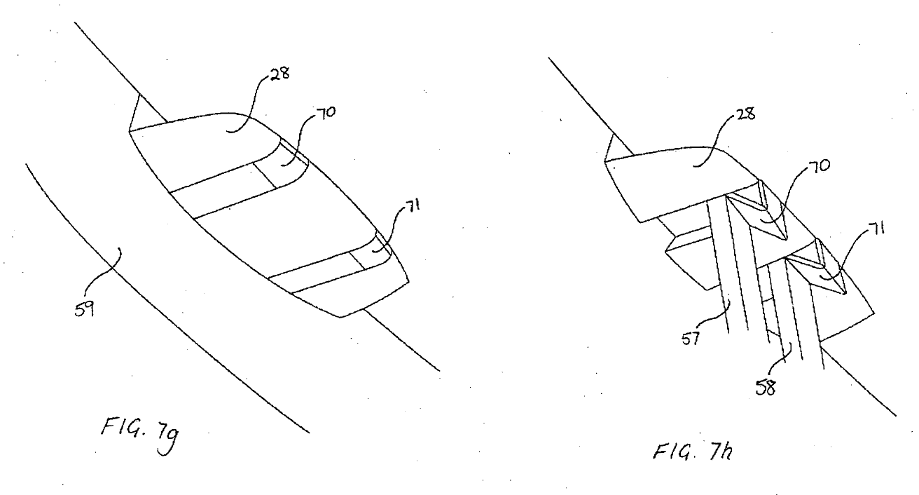

FIG. 7a to 7c shows in perspective view from above port stub wing 28 with the float in the retracted position. FIG. 7b is the same view but with the float in the deployed position for landing or take off on water, while FIG. 7c shows the beaching position, where the float is further extended to allow access of the wheel (not shown) to a solid surface. FIG. 7d is a side sectional view corresponding to that in FIG. 9a, while FIG. 7e is a side sectional view corresponding to FIG. 7b and FIG. 71f is a side sectional view corresponding to FIG. 7c.

As shown in FIG. 7a to 7f, each of arms 57 and 58 has a radiused end 67 and 68. In the float retracted position, radiused ends 67 and 68 resemble cuffs 62 and 63 in that they line up with the outer contours of stub wing 28. As the float is deployed, ends 67 and 68 are rotated around pivot point 69 corresponding to butt hinge 69a as shown in FIGS. 7d to 7f for arm 57. The radiused end 67 of arm 57 allows a tight fit between arm 57 and stub wing 28, as can be seen in FIGS. 7d to 7f.

Yet another embodiment is shown in FIGS. 7g and 7h, which show stub wing 28 in perspective view from below (port side). In this embodiment, arms 57 and 58 are joined to stub wing 28 by hinges 70 and 71. FIG. 7g shows how hinges 70 and 71 lie in line with stub wing 28 and do not create drag when the float is retracted, but are able to bend, as shown in FIG. 7h, to allow arms 57 and 58 to move during deployment of the float (not shown).

The US Specification disclosed articulation of the float tail so that one portion of the float, such as the rear portion, is movable with respect to the other portion (such as the front portion). One of the reasons for this, for example, is to enable the rear portion of the float to be raised during flight to reduce drag.

There are various ways in which the rear portion may be sealed with respect to the front portion. Some of those will now be disclosed.

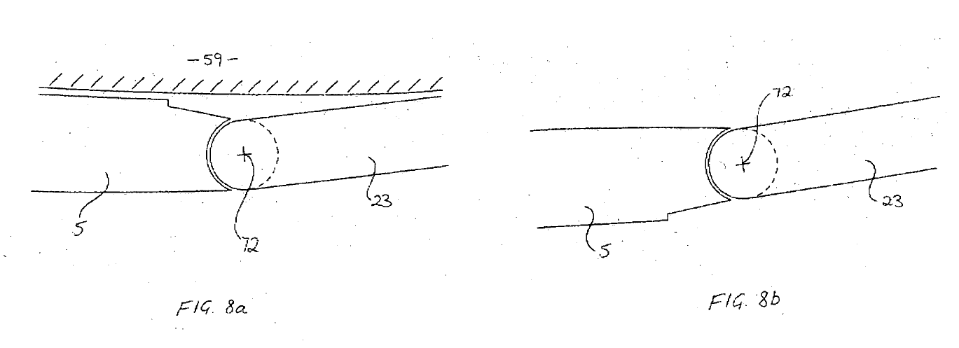

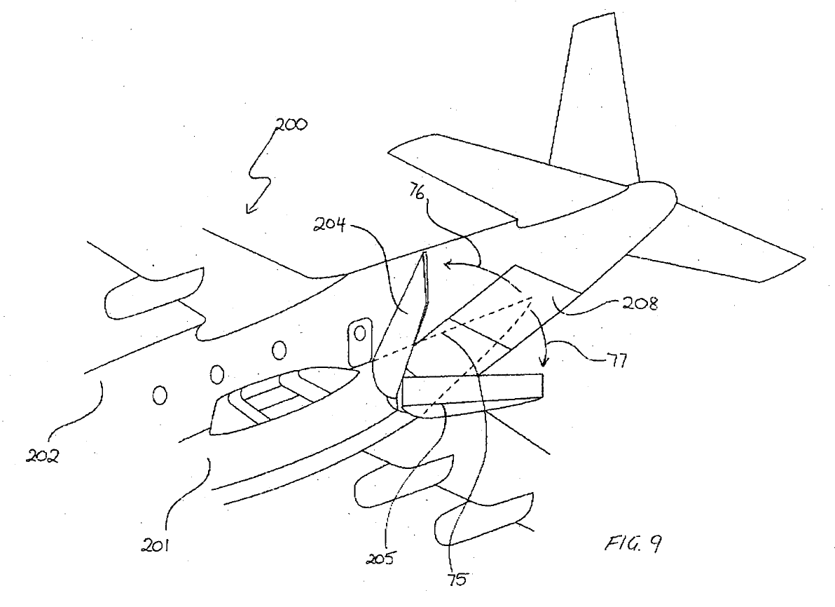

FIGS. 8a and 8b are sectional views on the keel line of float 5, square to the float tail pivot point. FIG. 8a shows part of the fuselage of aircraft 59 and part of float 5, when float 5 is in the retracted position. Rear float portion 23 is shown tilted upwardly towards aircraft 59, to reduce drag during flight. In this embodiment, float tail 23 pivots around pivot point 72. FIG. 8b shows the configuration when float 5 is deployed. The sealing of float tail 23 is based on “concentric cylinder” geometry.

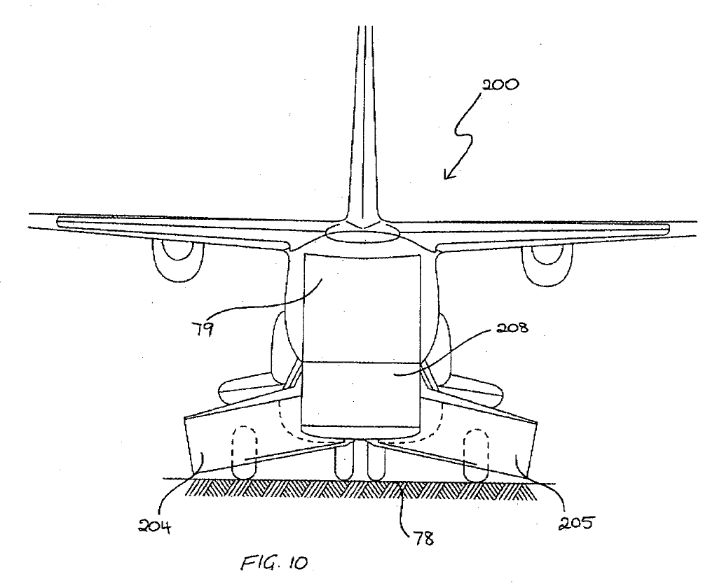

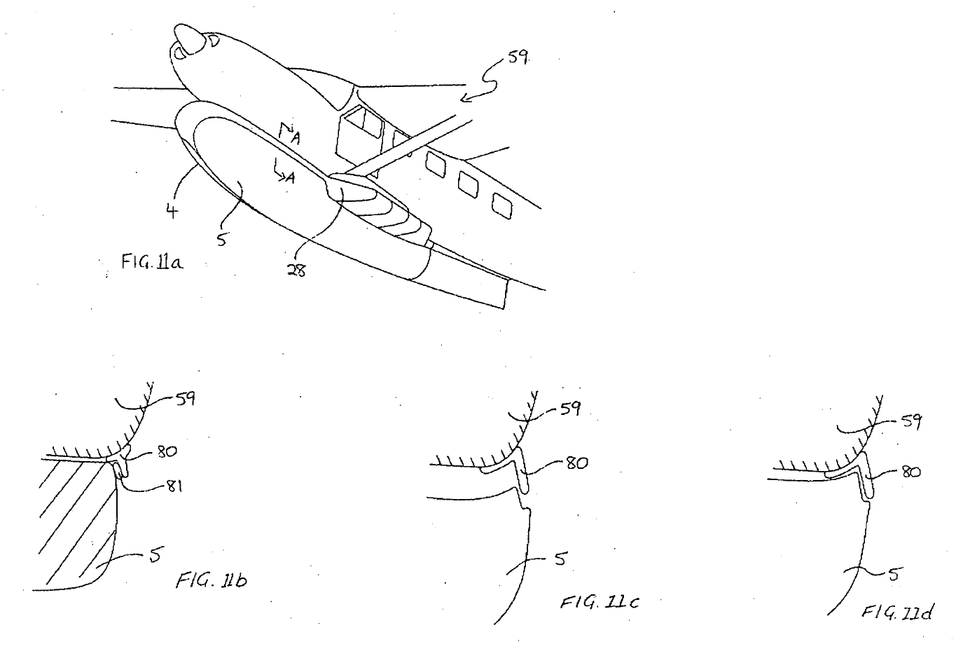

Not only can the rear float portion lift to nestle against the aircraft fuselage during flight, but also the rear float portions can move apart from each other to enable rear access to an aircraft. The rear tail portions may incline upwardly to allow access or may incline downwardly. These embodiments are illustrated in FIGS. 9 and 10. FIG. 9 is a partial view from below of an aircraft, from the tail end, while FIG. 10 is a rear elevation of the same aircraft.

In FIG. 9, which shows a Hercules aircraft 200 with a rear loading tailgate 208, rear tail portions 204 and 205 of floats 201 and 202 were originally closed together as shown by dotted line 75. To allow access to rear door 208, rear float portions 204 and 205 may be spread apart as indicated by arrows 76 and 77. Rear tail portions 204 and 205 may be retained in a tilted upwardly position or, as illustrated in FIG. 10, these may tilt downwardly to rest on runway 78. In oither configuration, access is facilitated to tail ramp 208.

If aircraft 200 is to be used for air drops, where items are to be ejected through tail hatch 79 while aircraft 200 is in flight, it is preferred that rear float portions 204 and 205 are in the lowered position, similar to that in FIG. 10.

It may be desirable to provide extra sealing of the floats to the aircraft. This can be accomplished in various ways, as exemplified below.

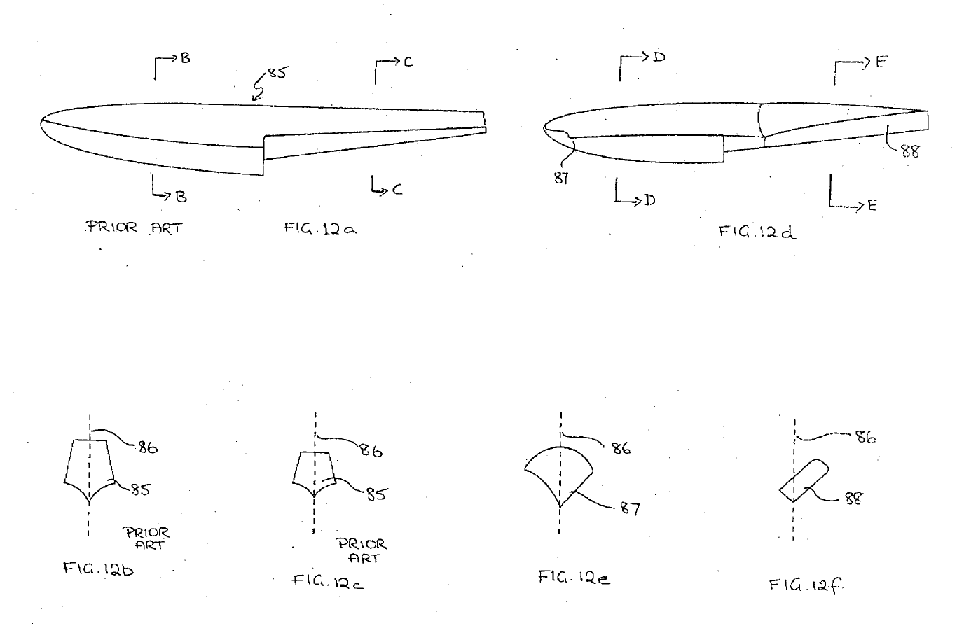

FIG. 11a is a perspective view from below of a twin float aircraft 59 having retractable floats 4 and 5, shown in the retracted position.

FIG. 11b is a sectional view taken along the line A-A in FIG. 11a. When floats 4 and 5 are retracted as shown in FIG. 11a, a “door frame” 80 including seal 81 assists in sealing float 5 to the fuselage of aircraft 59. This can also accommodate relative deflections between the fuselage of aircraft 59 and the floats 4, 5 whilst in flight. This latter advantage is shown in FIGS. 11c and 11d, where frame 80 is shown slightly rebated into float 5. As aircraft 59 undergoes deflection in respect to float 5 as shown in FIG. 11e, frame 80 helps to maintain a seal between aircraft 59 and float 5 during the extremes of movement shown by comparing FIG. 11c with FIG. 11d.

FIGS. 7a-7f above illustrated a method of joining the floats to stub wings. Different aspects of attaching floats are discussed below, with particular consideration to reducing drag in flight.

Floats 4 and 5 are preferably asymmetric in cross section, as opposed to prior an floats, which arc symmetrical about a centre line. This is illustrated in FIGS. 12a to 12f. FIG. 12a is a side elevation of a typical prior art. float 85. FIG. 12b is a cross sectional view of the forward part of float 85, taken along the line B-B in FIG. 12a. FIG. 12c is a cross sectional view of the rear part of float 85 taken along the line C-C of FIG. 12a. As can be seen, float 85 is symmetrical about centre line 86, both respect to the forward part of float 85 and the rear part of float 85.

This can be contrasted with the float subject of the present invention. Float 86 of FIG. 12d has forward portion 87 and rear portion 88, at least one being movable in relation to the other. A cross sectional view of forward portion 87, taken along the line D-D of FIG. 12d, is shown in FIG. 12e. The asymmetry about line 86 is illustrated. The asymmetry is even more pronounced in relation to the rear portion 88, the cross section taken along the line E-E in FIG. 12d being shown in FIG. 12f. Asymmetric floats can help to steer aircraft 59 in the desired direction of travel, for example.

Floats of the invention may incorporate ducts to assist in planing. Preferably, any such ducts are concealed during flights when the floats are retracted.

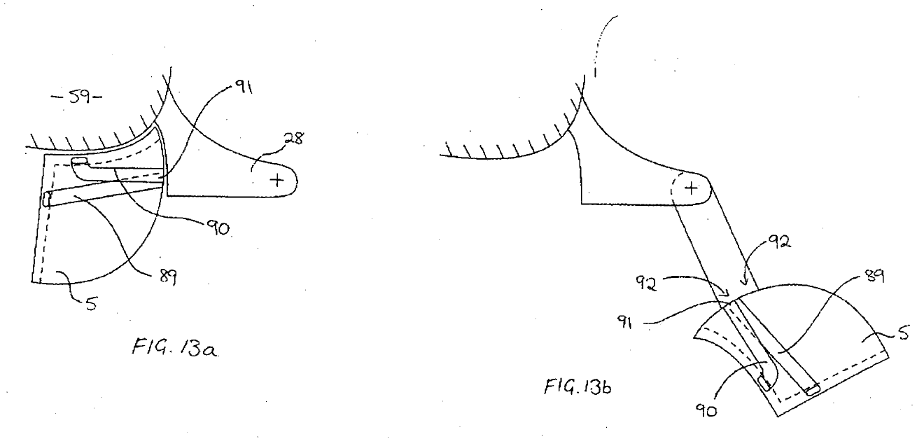

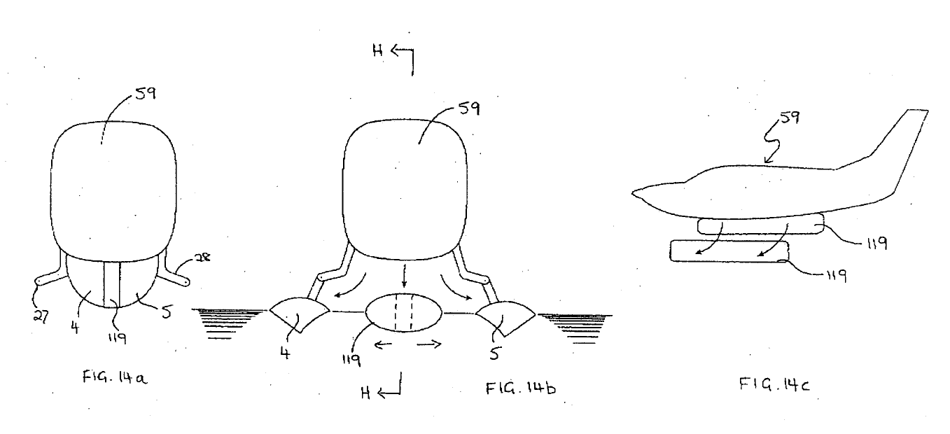

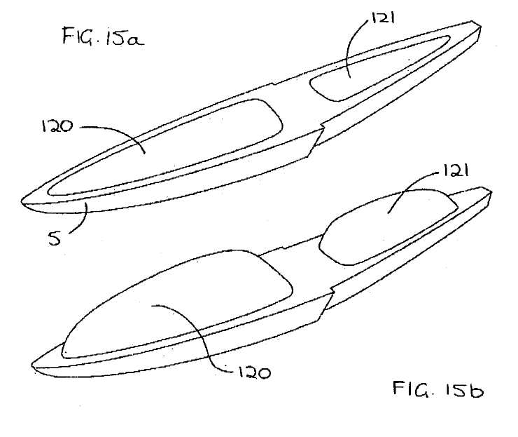

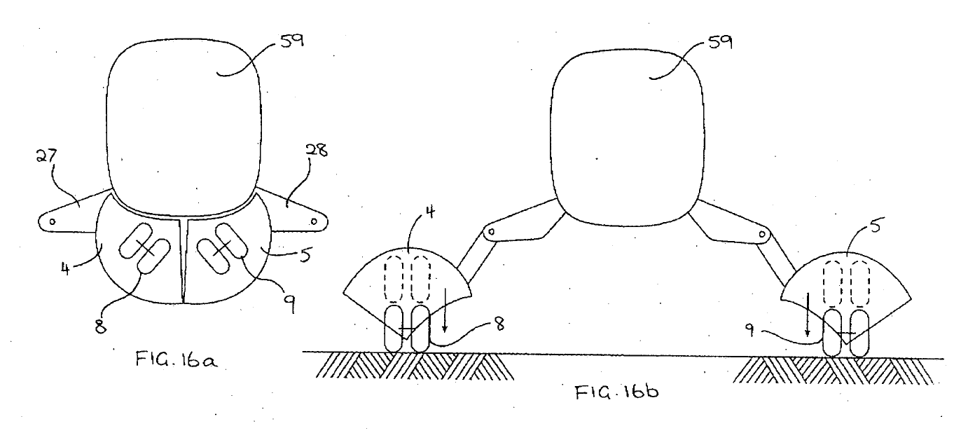

By way of example, reference is made to FIGS. 13a and 13b. FIG. 13a shows in section view part of a fuselage of an aircraft 59, having a stub wing 28 from which float 5 may be pivoted. FIG. 13a shows the retracted position, while FIG. 13b shows the position where float 5 is deployed for landing or take off on water. Arm 57, shown in dotted outline, joins float 5 to the fuselage of aircraft 59.

Float 5 includes ducts 89 and 90. As shown in FIG. 13a, the duct inlets 91 are covered by stub wing 28 hi the retracted position. In the deployed position shown in FIG. 13b, air enters the duct inlets 91 as shown by arrows 92 to increase planing during take off, reducing the distance required for take off.

Floats may be modified in various other ways. By way of example, a float of the invention may include means for reducing drag during flight, increasing tail area when floats are deployed and for streamlining shape.

Another aspect of the present invention is to provide means for varying volume of floats or floating means. The volume of the floats themselves may be varied, or a separate element may be introduced to provide volume variation.

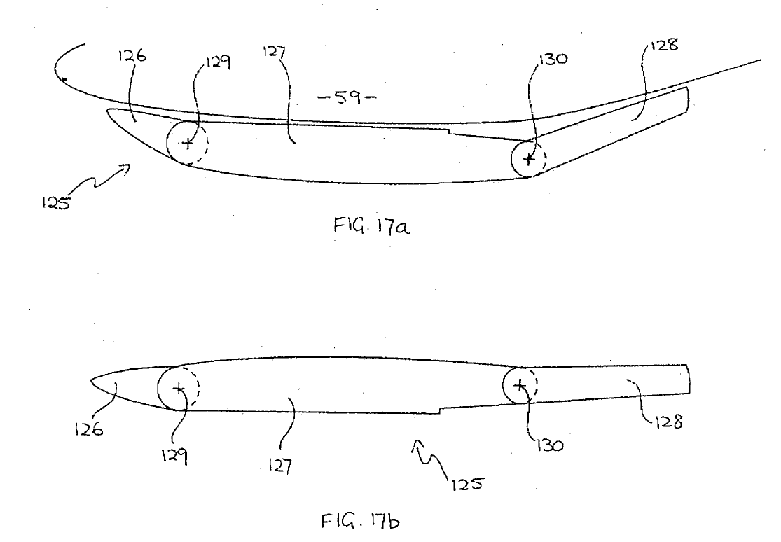

An example of the latter is shown in FIGS. 14a, b and c, which show in sectional view a twin float aircraft having a central pneumatic float 119. FIG. 14a shows central pneumatic float 119 in a deflated configuration, situated between (in this embodiment) fixed volume floats 4 and 5. Float 119 can be inflated as shown in FIG. 14b. Float 119 can swing down to the desired level as shown in the side view in FIG. 14c, looking in the direction of arrows H in FIG. 14b. In FIG. 14c, floats 4 and 5 are omitted for simplicity and float 119 is shown in both the retracted and deployed positions to illustrate both positions.

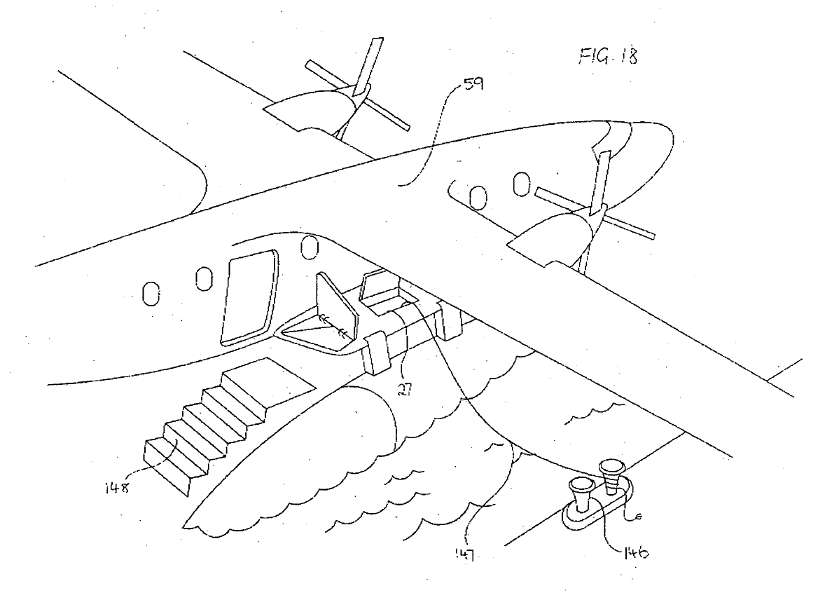

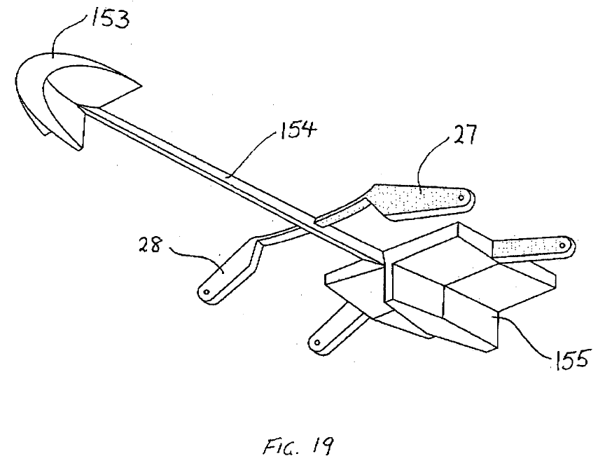

While the volume of floats 4 and 5 was fixed in the embodiment in FIG. 14, the volume may be varied as shown in FIGS. 15a and 15b. In FIG. 15a, float 5 has two pneumatic blisters 120 and 121 which are normally deflated as shown in FIG. 15a but which can be inflated to increase in volume as shown in FIG. 15b. Inflation may take place by any suitable means.

In one embodiment, the main wheel of the aircraft may be retracted into the floats. One way of achieving this is illustrated in FIGS. 16a and 16b, both of which are sectional views. Aircraft 59 is shown having stub wings 27 and 28, but in this embodiment stub wings 27 and 28 do not accommodate main wheels 8 and 9 and so can be somewhat smaller than might otherwise be the case. As shown in FIG. 16b, when floats 4 and 5 are in the deployed position, wheels 8 and 9 may be lowered, as shown in FIG. 16b, or retracted within floats 4 and 5. When floats 4 and 5 are themselves retracted against the fuselage of aircraft 59, wheels 8 and 9 are safely housed within floats 4 and 5.

In some respects the embodiment in FIG. 16b resembles the amphibious version of Caravan aircraft and the technology used with respect to such existing aircraft may be suitable for application to the embodiment shown in FIG. 16b.

The US Specification discloses angling of the rear portion of a float upwardly to reduce drag during flight. It has now been found that there can be advantages in having a three-part float, together with the ability to change the angle of the nose part of the float, so that the nose may be angled up towards the fuselage when the float is retracted.

An example of this is illustrated in FIGS. 17a and 17b, which show in side sectional view float 125 in the retracted position against the fuselage of aircraft 59 (FIG. 17a) and float 125 in the deployed position, omitting aircraft 59 (FIG. 17b). As can be seen from the FIGS. 17a,b, float 125 has three articulated portions: nose portion 126, central portion 127 and rear portion 128. Nose portion 126 can pivot with regard to central portion 127 at pivot point 129, while rear portion 128 can pivot in relation to central portion 127 at pivot point 130. When float 125 is in the retracted position, rear portion 128 can be pivoted upwardly, as can nose portion 126, to further streamline float 125 under the fuselage of aircraft 59. When float 125 is deployed, nose portion 126 can be pivoted to the optimum position, as can rear portion 128.

With regard to accommodating equipment, fuel, etc, in floats, providing access through floats, and accommodating wheels, etc, in stub wings, the twin float aircraft of the invention may be able to accommodate such items as docking or loading equipment, retracting into the stub wing or other parts of the aircraft. There are many ways to do this. One example is shown in FIG. 18 which is a partial perspective view from above of an aircraft 59 moored to bollards 146. Mooring rope 147 can be stored in stub wing 27, as can steps 148. Other docking and loading equipment, such as gangplanks, may be similarly stored. Other storage opportunities will be apparent to one skilled in the art.

In one aspect, the invention is concerned with the use of void spaces between retracted floats to accommodate structural components and/or ancillary equipment. The void spaces can be used in any desired way. An example is shown in FIG. 19, which is a perspective view, looking down, from the port side, of the space between a pair of floats 4 and 5 (not shown). The usable space includes nose fairing 153, spine 154, space 155 between float rear portions (useful for activation equipment) and space within stub wings 27 and 28 (beams only are shown).

It is within the scope of the invention to incorporate retractable floats on an aircraft with fixed wheels. One method for this is illustrated by FIG. 20a, which shows how float 4 can be pivoted as shown by arrows 174, 175 and 176 to clear fixed wheel 177. In this version, nose wheel 178 is located between the “bows” of the floats. The sweep or path 179 of the float 4 and the retraction arm 58 as they travel between the retracted and extended or air travel positions is indicated by the volume defined by V in FIGS. 20a and 20b as the float 4 and arm 58 rotate about pivot point 69.

The fixed wheel 177 of existing landing gear 180 does not intersect with the retractable float path volume V, although stub portion 28 supporting the retractable arms 58 may partially encase the existing leg 181 of the landing gear 180. However, retractable arms 59 travel through arcs about pivot point 69 of butt hinges 69a on either side of the respective existing wheels 177 whereby the position of the wheels 177 are not affected and they are operational when the floats 4,5 are either in the fully retracted position A, the beach landing or take off position B, but the float deployed position C.

Referring to FIG. 20c, it is clear that the floats 4,5 according to an aspect of the present invention have a deep V hull 182 and a large volume upper casing 183. The upper casing 183 is tall in terms of end view dimensions compared to prior art floats and provides improved buoyancy in rough or choppy water. The consequence is a better and more comfortable ride to the passengers and the aircraft's component parts are subjected to less structural fatigue because the floats 4,5 tend to cut through the chop. However, longer takeoff distances may be experienced because of the diminished capacity of the floats 4,5 to plane compared to prior art floats. The superior buoyancy of the taller upper casing 183. to some extent compensates for the deep V float's 4,5 tendency to develop a resonating roll in slight sea swells when the aircraft is at rest. The apex 185 of the upper casing 183 is, in end view, vertically non-aligned with the hull's apex 184, unlike the prior art, and provides an improved and strengthened hull structure in which the transverse axis 186 of the hull 182 is generally aligned with the retractable arms 58.

The invention can be adapted to suit various other types of aircraft, including, for example, short nose single tractor propeller aircraft. An example is shown in FIGS. 21a and 21b. Deployed floats 4,5 need to be located in a more forward position for this type of aircraft, as shown in FIG. 21b, but may be moved aft to a stowed position when retracted, as seen in FIG. 21a.

Some other aspects of the invention, which are not concerned with retractable twin float aircraft, will now be described.

In a further aspect, the invention provides a pannier with integrated wheels, but without the retractable float feature. Such a pannier may be independent of the aircraft undercarriage. This aspect of the invention can provide an increased volume for freight and equipment compared with prior art panniers. Prior art panniers are integrated with the existing walls of the host plane, whereas in the case of the present invention the pannier is independent and the wheels are integrated with the pannier.

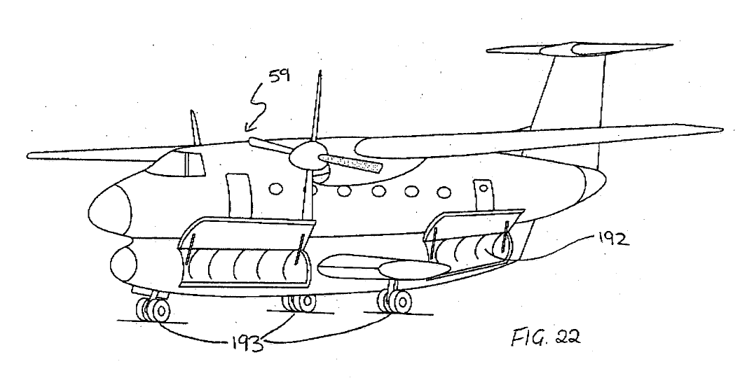

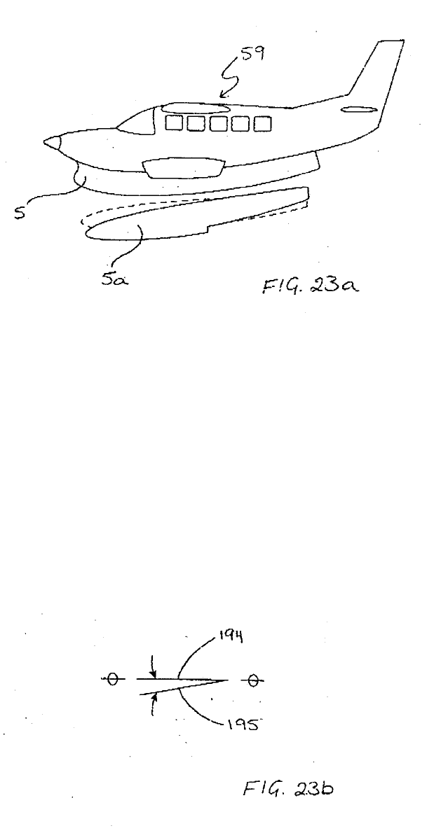

One embodiment of this aspect of the invention is shown in FIG. 22, which is a perspective view of an aircraft 59 having a pannier 192 in place. Pannier 192 includes integrated wheels 193. Any desired number of wheels may be integrated, to suit the purpose, size, etc of the host plane.

In a further aspect, the invention provides a float for an aircraft, the float being capable of achieving an increased “nose down” angle in the water. Preferably, the float of this aspect of the invention is the type of retractable float referred to above. However, this aspect of the invention may also be applicable to fixed floats.

As will be appreciated by one skilled in the art, if the float can have an increased “nose down” angle, this can achieve a favourable angle of incidence of the wing relative to the fuselage and increase clearance between the propeller and the water.

The float may be caused to pivot to achieve the desired angle by any suitable method and using any suitable means.

One embodiment of this aspect of the invention is illustrated in FIGS. 23a and 23b. FIG. 23a shows in side elevation an embodiment of aircraft 59 having, in this case, retractable floats, only one of which is visible at 5. When deployed, float 5 is shown at 5a. The dotted line represents the normal location of deployed float 5a. The solid outline shows deployed float 5a after the “nose down” angle has been increased.

FIG. 23b indicates the normal horizontal line 194 and the deviation when the float is angled at 195. The angle between lines 194 and 195 may be chosen to suit the desired application but typically may be between 1° and 10°, more preferably between 1° -5°, sill more preferably between 2° and 2.5°, and most preferably 2.25°.

It may also be desirable to slightly angle float 5a outwardly through a substantially horizontal plane from aircraft 59, for example, by as much as 5°, but preferably by no more than a degree or so.

In a further aspect, the invention provides a four-winged aircraft having a pair of main wings and a pair of canard or forward wings. Optionally, a pair of wings, in each case, may be provided as a single unit, sometimes regarded as a single wing.

In the new aircraft of the invention in this aspect, propellers may be provided on the main wing or on a tail for the aircraft. In the latter case, it is preferred that the tail is V-shaped, with one tractor propeller engine mounted on each arm of the V. Optionally, each version of the new aircraft of the invention may incorporate the retracting float system of the invention.

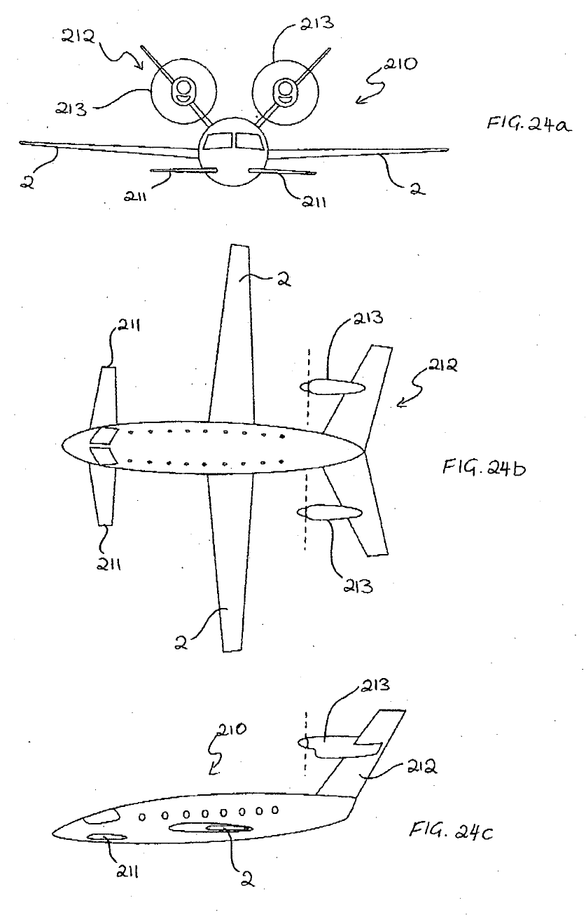

An embodiment of the winged version of the new aircraft is shown in FIGS. 24a, b and c.

FIG. 24a is a front elevation of aircraft 210 having main wings 2 and forward mounted canard wings 211. V-shaped tail 212 supports on each arm a tractor propeller engine 213.

FIG. 24b shows aircraft 210 in plan view from above, while 24c is a side elevation.

It has been found that using canard wings 211 towards the front of the aircraft can increase lift.

In a further aspect, the invention provides a modified flying boat. The flying boat of the invention has a rear part of the fuselage provided in two sections capable of moving apart to provide access to rear loading means. This has not been possible with prior art flying boats. The rear sections may move apart in a similar manner to the rear float portions described above in connection with FIG. 9, for example.

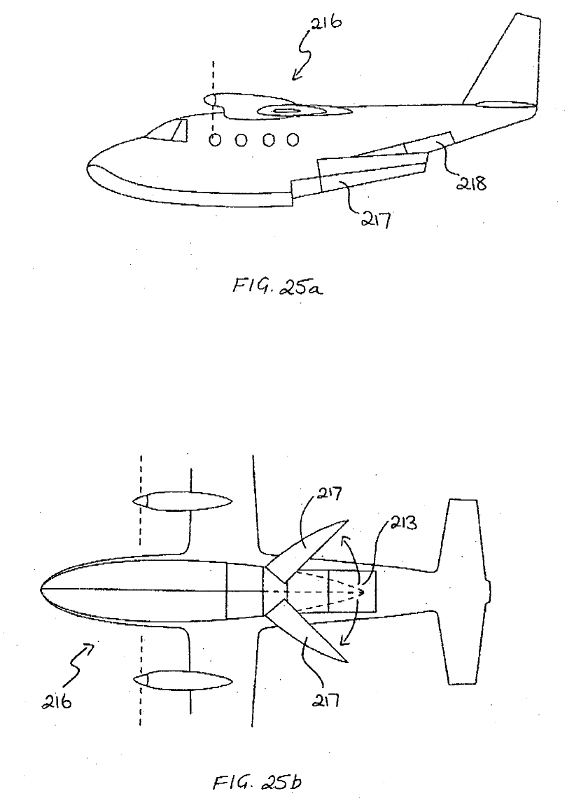

An embodiment of the flying boat of the invention is illustrated in FIGS. 25a and 25b. FIG. 25a is a side elevation of flying boat 216 having rear sections 217 and a loading hatch or ramp 218. FIG. 25b is a plan view from below of flying boat 216, showing how rear sections 217 can swing apart for access to ramp 218. The dotted lines represent the closed configuration of rear sections 217.

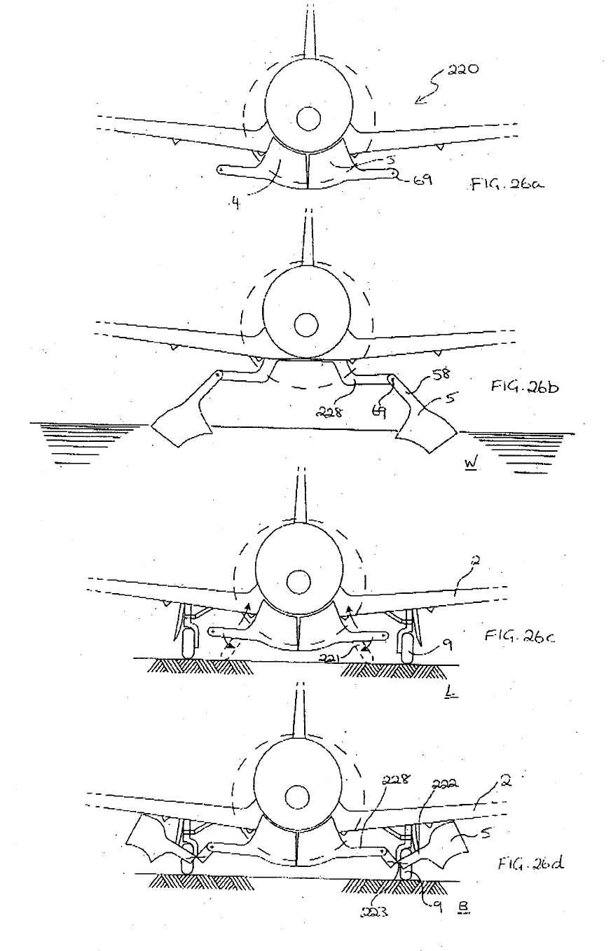

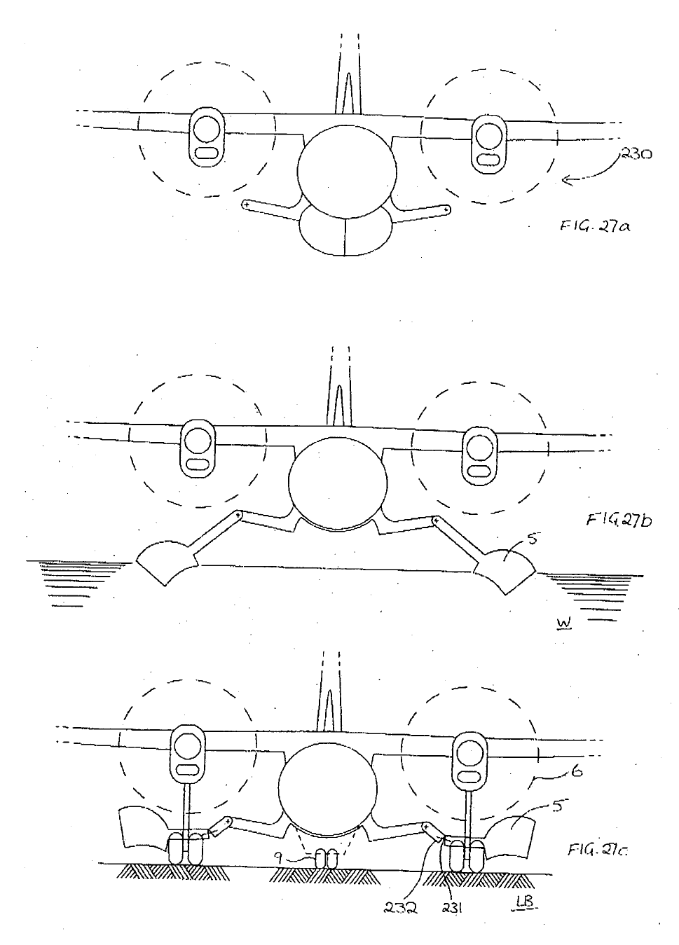

Referring to FIGS. 26a-26d there is shown a partial end sectional view of a Pilatus PC12 aircraft 220 having a pair of retractable floats 4, 5 pivotable on hinges about pivot point 69. In FIG. 26a, the retractable floats 4,5 are shown in the retracted position corresponding to air travel in which drag is minimised by positioning the floats 4,5 snug against the underside of the fuselage of the aircraft 220.

In FIG. 26b, the float 5 is shown in a deployed position corresponding to water travel, either when moored or stationary, or when taking off or landing on water W. Referring to FIG. 26c, the aircraft's 220 landing gear 9 is shown in its deployed position. Because the stub portion 228 of float 5 would otherwise obstruct the movement of the landing gear 9 from its retracted position shown in FIG. 26a through to its deployed position shown in FIG. 26c, the stub wing 228 is provided with an articulated panel 221. The panel may be dropped out of the plane of the stub wing 228 to allow the undercarriage 9 to pass through to its deployed position shown in FIG. 26a or to return as required. The undercarriage wheel 9 rests on the land surface L.

In FIG. 26d, a beach take off or landing configuration is shown in which the undercarriage wheel 9 is deployed, its deployment from the retracted position made possible by moving the drop panel 221 out of the plane of the stub wing 228. The float is shown in an extended position whereby to clear the surface of the beach sand B on which the aircraft 220 is either taking off or landing. The float 5 arm 58 is further articulated by a second hinged portion 222, actuated by an hydraulic ram shown schematically at reference number 223 to permit the float 5 to be positioned both clear of the underside of the main wing 2 and the top surface of the beach, as shown in FIG. 26d.

Landing gear wheels 9 extending from the fuselage of the aircraft 230 are lowered for the purposes of take off or landing and clearance is therefore provided by extending the float 5 to a non-operative position clear of the propeller 6 and the land/beach LB.

Referring to FIGS. 27a-27c a further example is shown where it is possible to retain the existing undercarriage, as with the example shown in FIGS. 26a-26d, this time in relation to a Bombardier Dash 8 tah aircraft 230. The float 5 is deployable as shown in FIG. 27b to land on or take off from water (W). As further shown in FIG. 27c, the float 5 is further articulated by the provision of an extra link 231 to enable the float to be extended to a position just above the beach or land (LB), the link 231 operable by a hydraulic ram 232 shown schematically in FIG. 27c, as well as being positioned low enough to be clear of the sweep of rotatable propeller 6.

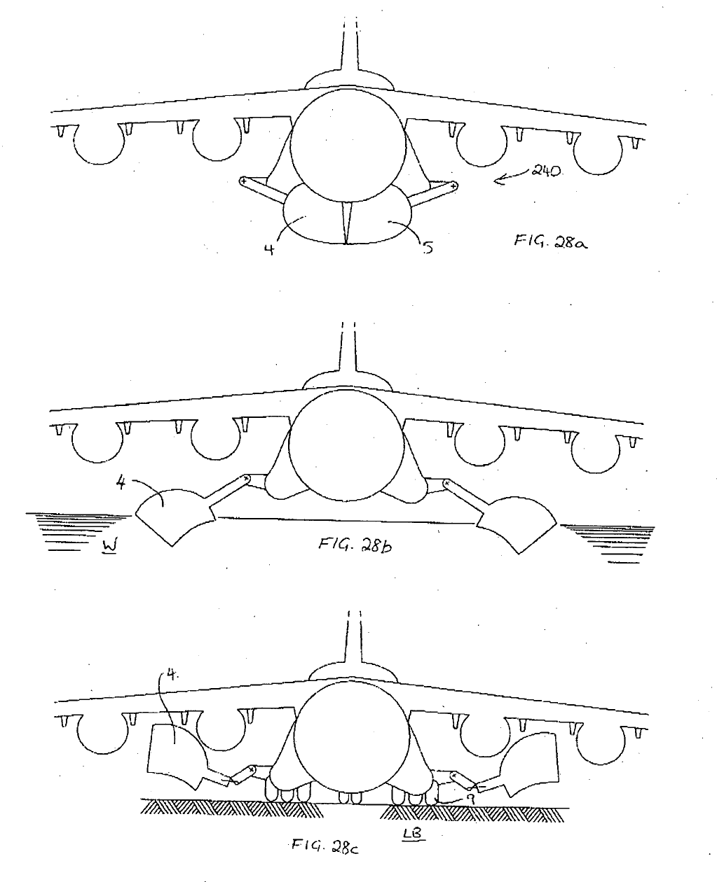

Referring to FIGS. 28a-28c, an arrangement similar to that shown in relation to FIGS. 27a-27c is illustrate with reference to a C17 tactical transport aircraft 240 in which the floats 4,5 are shown in retracted position for air travel in FIG. 28a, in a deployed position for water take off or landing in FIG. 28b and in an extended, non-deployed position in FIG. 28c whereby to allow clearance for undercarriage wheels 9 of the existing aircraft 240 to be deployed for land or beach travel during take off or landing.

The above examples show in FIGS. 26a-28c demonstrate how it is possible to retain the existing undercarriage of an aircraft 220, 230, 240 for a fit out as a float plane in accordance with the present invention. Another example of this is shown with reference to FIG. 20 above. In these examples, the existing retractable undercarriage (wheel 9) is retained in use and the retracting float “kinemetics” is adapted to suit each application corresponding to the existing aircraft configuration.

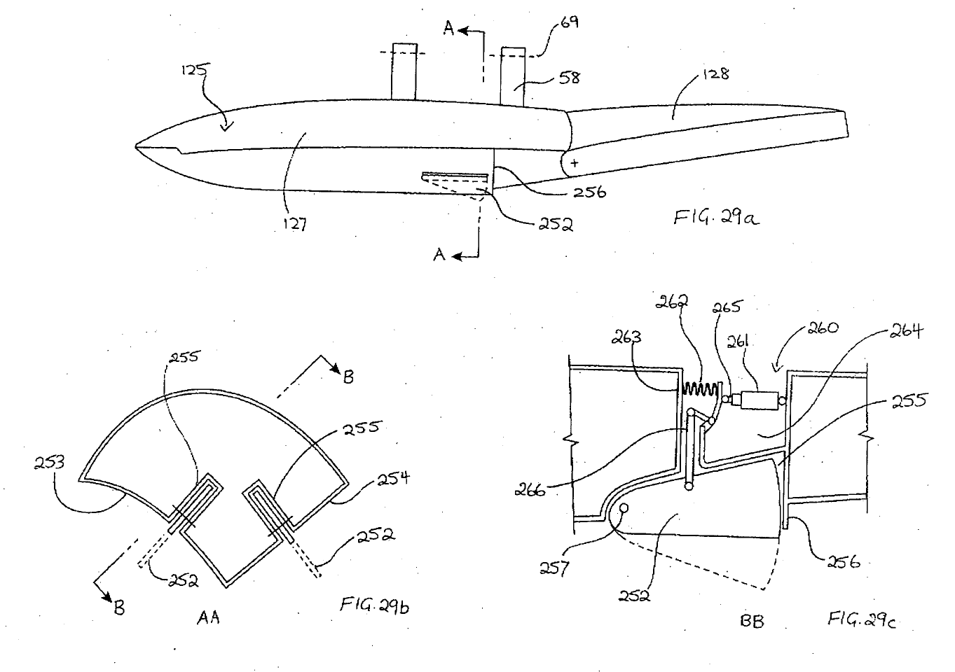

With reference to FIG. 29a-29c, there is provided in a float 125 having a main body 127, and a tail section 128 and a strake 252 that operates as a deployable higher lift device adapted to shorten the take off run of an aircraft.

In one aspect of the present invention, the articulated high lift device 128 that can be deployed to assist take off and that can be retracted during landing and taxying. Referring specifically to FIG. 29a, the strake 252 is provided in one or both undersides surfaces 253,254 of the float 125. When, retracted, the strake 252 provides only a small amount of drag below the float 125 hull, whereas when lowered offers considerable extra area for the aircraft to plane on, just prior to take off. In FIG. 29b, the strakes 252 are shown in their retracted positions within a strake well 255 in FIGS. 29a-c. The strakes 252 are shown in an extended configuration by the broken lines.

With specific reference to FIG. 29c, the strake 252 is retractable into the well 255 defined by a recess bordered by a rear step 256. The strake 252 is pivoted about a hinge 257 and operated by actuation of a ram mechanism 260. The ram mechanism 260 includes a ram 261 that pushes the strake 252 down via a bell crank. The ram 261 acts against the bias of a spring 262 secured against internal float wall 263 defining cavity 264 in which the ram mechanism 260 is housed. The ram piston 265 is connected to the strake 252 by a series of linkages 266. Accordingly, actuation of the ram 261 against the bias of the spring 262 causes deployment of the strake 252 as required.

It is to be understood that the embodiments shown above are illustrative and not intended to be limiting on the scope of the invention. Many modifications and variations may be made to the embodiments described herein without departing from the spirit or scope of the inventions.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the float or the existing landing gear lowermost.

It will be appreciated by those skilled in the art that many modifications and variations may be made to the methods of the invention described herein without departing from the spirit and scope of the invention.

1. A method of retrofitting at least two retractable floats to an aircraft having;
existing solid surface landing gear to equip said aircraft to optionally takeoff from or land on a solid surface or on a water surface; and
one or more main wings,
said method including, in no particular order, the steps of:
a) mounting at least one float retraction arm to said aircraft so said existing landing gear can be optionally used to take off from or land said aircraft on a solid surface;
b) attaching said floats to said at least one float retraction arm;
and wherein the method further includes the steps of:
c) mounting said at least one float retraction arm to a pivot point below the one or more main wings; and
d) moving said floats to an air travel position which minimises drag by securing said floats close to each other and the fuselage of said aircraft or moving said floats to a deployed position in which said floats are positioned outwardly and away from said fuselage and each other so that the float retraction paths of travel of said float retraction arms and said floats between said air travel and said deployed positions do not intersect with said existing landing gear in said existing landing gear's position for landing on or taking off from a solid surface.

2. The method according to claim 1, wherein in step d) said existing landing gear is in the same fixed position for both for landing and air travel and said float retraction paths do not intersect with said fixed existing landing gear.

3. The method according to claim 1, wherein said existing landing gear is the main landing gear and said method includes a further step for landing on a beach or other solid surface of:
e) moving said at least one float retraction arm to position said floats in a non-deployed extended position for landing on a solid surface whereby, in the extended position, said floats are higher than the lowermost point of said existing main landing gear.

4. A method according to claim 1, wherein, in said step d), said floats are moved to the deployed position from the air travel position by rotation of said at least one float retraction arm about an axis aligned substantially horizontally and longitudinally parallel relative to the fuselage so that the surface of each of said floats facing said fuselage when in said air travel position is generally downward facing when in said deployed position.

5. An aircraft having existing landing gear, said aircraft retrofitted with at least two retractable floats to equip said aircraft to optionally takeoff from or land on a solid surface or a water surface, the aircraft including one or more main wings and a float arrangement having:
a) at least one float retraction arm mounted to said aircraft so said existing landing gear can be optionally used to take off from or land on a solid surface; and
b) said floats attached to said at least one retraction arm, wherein
c) said at least one float retraction arm is mounted at a pivot point below the one or more main wings; and
d) said floats include an air travel position which minimises drag by securing said floats close to each other and the fuselage of said aircraft and a deployed position in which said floats are positioned outwardly and away from said fuselage and each other so that the float retraction paths of travel of said at least one float retraction arm and said floats between said air travel and said deployed positions do not intersect with said existing landing gear in said existing landing gear's position for landing on or taking off from a solid surface.

6. The float arrangement of the aircraft defined in claim 5, wherein one of the underside surfaces of each of said floats in the deployed position faces the fuselage in the air travel position.

7. The float arrangement of the aircraft defined in claim 5, wherein each of said floats includes a float body and a tail section articulated relative to said float body to provide loading or unloading access to a tailgate of said aircraft.

8. The float arrangement of the aircraft of claim 5, wherein said at least one retraction arm is mounted to said aircraft by a cylindrical butt hinge in which said retraction arm has a radiused end received within said butt hinge.

9. The float arrangement of the aircraft defined in claim 5, wherein said existing landing gear is retractable and said at least one float retraction arm and/or each of said floats include a deflectable portion which, when in the air travel position, would interfere with the path of travel of said solid surface landing gear during extension or retraction.

10. The float arrangement of the aircraft defined in claim 5, wherein each of said floats includes an underside side wall surface and a retractable strake provided in said underside-sidewall surface, said strake deployable during takeoff to increase the water engaging surface area of said floats.

11. The float arrangement of the aircraft of claim 5, wherein each of said floats includes a float body and a tail section articulated relative to said float body that is deployable to provide improved buoyancy and retractable to reduce drag.

12. The float arrangement of the aircraft of claim 5, wherein said float arrangement includes a sealing frame which, in said air travel position, helps maintain a seal between said fuselage and each of said floats during extremes of movement.

13. The float arrangement of the aircraft defined in claim 5, wherein each of said floats includes duct inlets to increase planing during take off.

14. The float arrangement of the aircraft of claim 12, wherein said sealing frame is rebated into each of said floats or a seal is provided on each of said floats or said fuselage.

15. The float arrangement of the aircraft defined in claim 5, wherein each of said floats includes a float body and an articulated nose section pivotable relative to said float body.

16. The float arrangement of the aircraft of claim 6, wherein said underside surface includes at least one duct inlet of a duct to induce drag and increase planing during takeoff in the deployed position and said duct inlet is sealed during flight in the air travel position without the need for a closure to close the inlet duct.

17. The float arrangement of the aircraft defined in claim 5, wherein each of said floats is attached to a canard stub wing by said at least one float retraction arm.

18. The float arrangement of the aircraft of claim 5, wherein said aircraft includes a forward pair of stub wings opposed to each other across said fuselage and a rearward pair of stub wings opposed to each other across said fuselage, said at least one float retraction arm mounted to at least one of said stub wings.

19. The float arrangement of the aircraft defined in claim 5, wherein each of said floats includes a float body having a hull with a dead rise angle of greater than 31.5°.

20. The float arrangement of the aircraft defined in claim 5, wherein each of said floats has a cross-sectional asymmetrical deep-V-shaped configuration having a pair of underside side wall surfaces joined at a lower-most hull apex in the deployed position.
